(19) United States
(12) Patent Application Publication
(10) Pub. No.: US 2009/0195629 A1
(43) Pub. Date: Aug. 6, 2009

(54) MEDIUM PROCESSING DEVICE

(75) Inventors: Koji Yamada, Okaya (JP); Tomohisa Kano, Shiojiri (JP)

Correspondence Address: EDWARDS ANGELL PALMER & DODGE LLP, P.O. BOX 55874, BOSTON, MA, 02205, US

(73) Assignee: SEIKO EPSON CORPORATION, Tokyo (JP)

(21) Appl. No.: 12/362,757

(22) Filed: Jan. 30, 2009

(30) Foreign Application Priority Data
Jan. 31, 2008 (JP) 2008-021940

(51) Int. Cl. B41J 2/01

(52) U.S. Cl. 347/104

(57) ABSTRACT

A medium processing device is provided. A case defines a space. A storage unit is configured to store a medium. A media drive is operable to perform at least one of writing data on the medium and reading data from the medium. A liquid ejecting unit is operable to eject liquid onto a surface of the medium. An air introducing port is configured to introduce air into the space from outside of the space. An air discharging port is configured to discharge the air to the outside from the space. The space includes a first part in which the media drive is disposed, a second part in which the liquid ejecting unit is disposed and a third part in which the storage unit is disposed. The air introducing port is provided in the first part and the air discharging port is provided in the second part. The first part, the second part and the third part are disposed so that the air is introduced into the first part, flows through the third part and is discharged from the second part.

Priority is claimed to Japanese Patent Application No. 2008-021940 filed Jan. 31, 2008, the disclosure of which, including the specification, drawings and claims, is incorporated herein by reference in its entirety.

### BACKGROUND

The present invention relates to a medium processing device including a media drive that writes data on media such as CDs or DVDs and/or reads data from the media and a liquid ejecting unit that ejects a liquid onto a label surface of the media.

In recent years, medium processing device such as a disc duplication device has been used for writing data on media (information recording media) such as plural sheets of blank CDs (Compact Discs) or blank DVDs (Digital Versatile Discs), and medium processing device such as a CD/DVD publisher capable of writing data and performing label printing has been used to prepare and issue media. A known medium processing device includes a media drive that writes data on a medium, a label printer that performs label printing on a label surface of the medium, and a medium transporting mechanism that holds and transports the medium to the media drive or the label printer (for example, see U.S. Pat. No. 5,734,629).

In order to improve a writing quality of the media drive, an ambient temperature of the media drive has to satisfy an operation guarantee temperature. In order to satisfy the operation guarantee temperature, a method of introducing air into the inside of the medium processing device from the outside to cool the media drive and to prevent the operation guarantee temperature from increasing can be taken into consideration. However, introducing air into the medium processing device from the outside may cause a minute ink mist, which occurrs as the label printer performs printing on the label surface of the medium, to diffuse to the medium processing device. Therefore, a problem occurs in that the medium stackers, the medium received in the medium stackers, and a power unit may be stained by the diffused ink mist. Another problem occurs when the air introduced inside the medium processing device is discharged from a gap in the medium processing device in that a bottom surface or a wall surface in the vicinity of the gap may be stained.

### SUMMARY

It is therefore an object of at least one embodiment of the invention to provide a medium processing device capable of restraining an ink mist from diffusing inside and outside, while cooling a media drive to maintain an operation guarantee temperature.

According to an aspect of at least one embodiment of the invention, there is provided a medium processing device, comprising: a case defining a space; a storage unit configured to store a medium; a media drive operable to perform at least one of writing data on the medium and reading data from the medium; a liquid ejecting unit operable to eject liquid onto a label surface of the medium; an air introducing port configured to introduce air into the space from outside; and an air discharging port configured to discharge the air to the outside from the space, wherein the space includes a first part in which the media drive is disposed, a second part in which the liquid ejecting unit is disposed and a third part in which the storage is disposed; wherein the air introducing port is provided in the first part and the air discharging port is provided in the second part; and wherein the first part, the second part and the third part are disposed so that the air is introduced into the first part, flows through the third part and is discharged from the second part.

The medium processing may further comprises a fan that is configured to allows the air to flow from the outside into the first part through the air introducing port, wherein the air introducing port is provided with the fan.

With the above-described configuration, the fan introduces the air from the outside into the first part in order to cool the media drive. The introduced air passes through the third part. And the air is discharged from the second part in which the liquid ejecting unit is disposed to the outside. Accordingly, the mist generated by the liquid ejecting unit does not flow into the third part. Accordingly, it is possible to effectively restrain the mist from diffusing without staining the medium stored in the third part, while cooling the media drive to maintain an operation guarantee temperature.

The medium processing device may further comprise a filter that is configured to absorb the liquid diffused in the form of a mist, wherein the air discharging port is provided with the filter.

With the above configuration, the filter provided in the discharging port adsorbs the mist generated by the liquid ejecting unit. Accordingly, it is possible to restrain the mist from diffusing inside and outside, while cooling the media drive to maintain the operation guarantee temperature.

The medium processing device may further comprise a fan that is configured to allow the air to flow from the second part to the outside through the air discharging port, wherein the air discharging port is provided with the fan.

With the above configuration, since the air from the third part is forcibly discharged from the second part, a possibility that the mist occurs is further decreased, and it is possible to obtain an advantage of capturing air containing the ink mist by the mist adsorption filter using a stronger air stream.

The liquid ejecting unit may include an ink-jet printer that is operable to print on the label surface of the medium. The storage unit may include a stacker that is configured to accommodate the medium and is detachably mounted in the third part. Accordingly, the ink mist of the ink-jet printer is not attached to the stacker and thus does not stain the stacker.

The medium processing device may further comprise a power unit of the medium processing device, wherein the power unit is disposed in the first part. Accordingly, it is possible to prevent deterioration in safety caused due to the attachment of the mist.

The medium processing device may further comprises a medium transporting mechanism which is operable to transport the medium between the storage unit and a tray of the media drive or a tray of the ink-jet printer, wherein the transporting mechanism is disposed in the third part.

With the above-described configuration, a stream is generated by allowing the air introduced from the outside by the fan to flow in the media drive, the medium transporting mechanism, and the liquid ejecting unit and discharging the air through the air discharging port. Accordingly, it is possible to restrain the ink mist from diffusing to the medium transporting mechanism and thus prevent the ink mist from being attached to the medium.

The medium processing device may further comprise: a printing head of the liquid ejecting unit; and an encoder plate which is operable to detect a location of a tray of the liquid ejecting unit; wherein encoder plate is spaced apart from the printing head.

With the above-described configuration, the attachment of the ink mist to the encoder plate is prevented and thus high location detection precision of the tray is maintained. Accordingly, it is possible to maintain a good quality of liquid ejecting unit.

### BRIEF DESCRIPTION OF THE DRAWINGS

The advantages of the present invention will become more apparent by describing in detail preferred exemplary embodiments thereof with reference to the accompanying drawings, wherein:

FIG. 1 is a perspective view illustrating the outer appearance of a disc publisher (the medium processing device) in a state where each unit is closed;

FIG. 2 is a perspective view illustrating the outer appearance of the disc publisher in FIG. 1 in a state where each unit is opened;

FIG. 3 is a perspective view illustrating the disc publisher viewed from an upper front side in a state where a case of the disc publisher is removed;

FIG. 4 is a perspective view illustrating a label printer installed in the disc publisher;

FIG. 5 is a perspective view when the publisher is viewed from a rear side;

FIG. 6 is a sectional view illustrating the disc publisher taken along the line VI-VI of FIG. 5;

FIG. 7 is a plan view illustrating a portion in which the media drives are installed in view of an upper side in FIG. 6;

FIG. 8 is a perspective view illustrating the label printer installed in the disc publisher in FIG. 1;

FIG. 9 is a schematic plan view illustrating a belt driving mechanism in FIG. 8; and

FIG. 10 is a schematic diagram illustrating air stream in the disc publisher in FIG. 1.

### DETAILED DESCRIPTION OF THE EMBODIMENTS

Hereinafter, a medium processing device will be described with reference to the drawings according to an exemplary embodiment of the invention.

In particular, a disc publisher that is an example of the medium processing device will be described according to the embodiment.

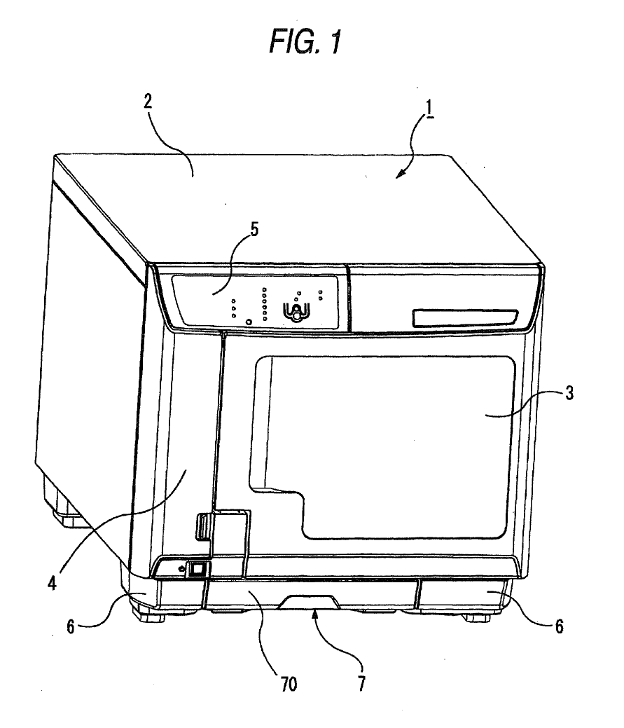

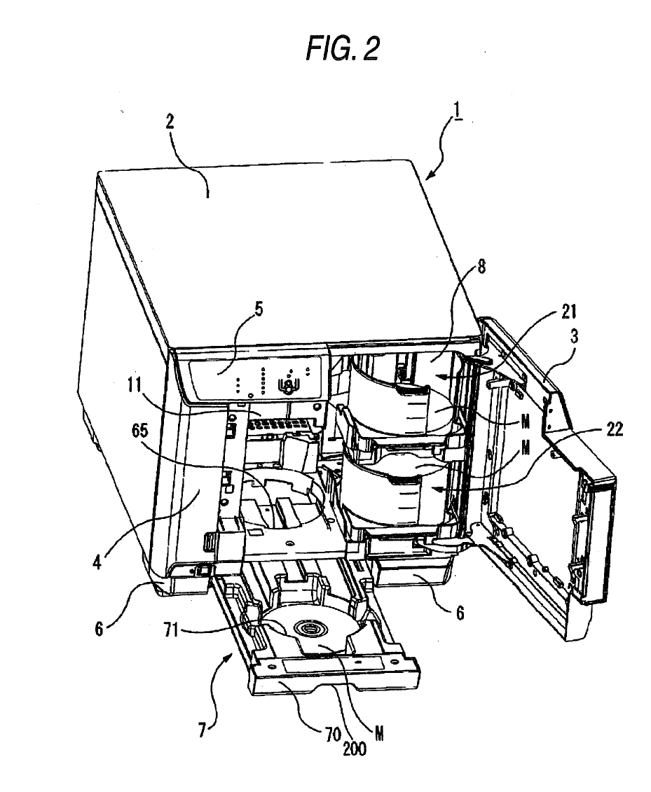

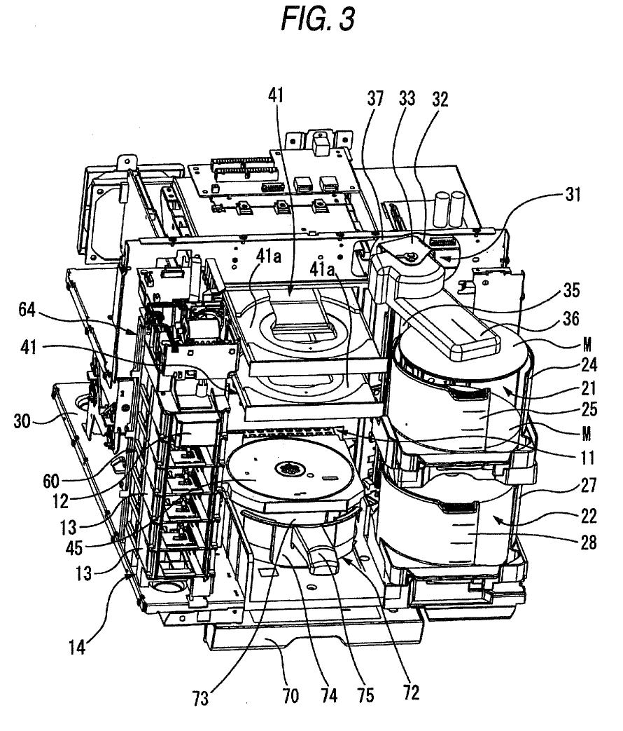

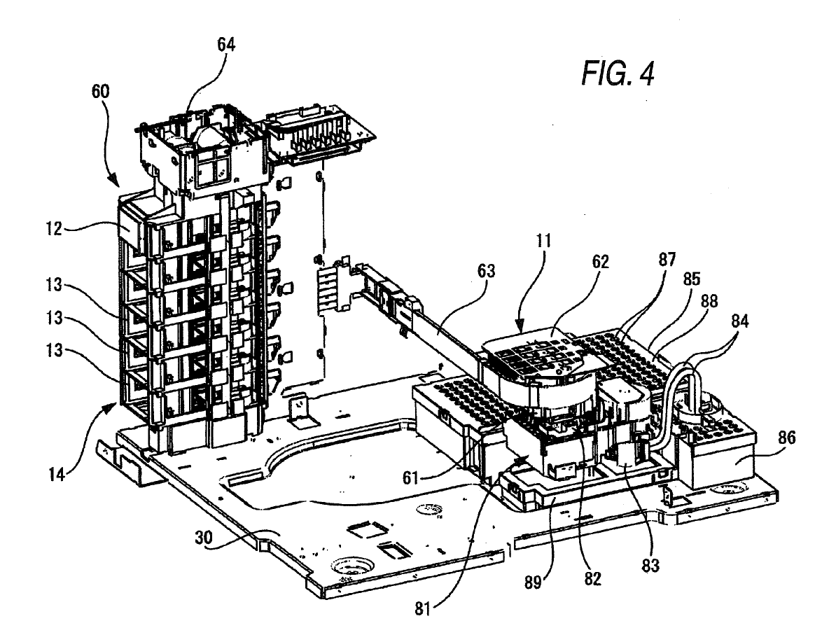

FIG. 1 is a perspective view illustrating the outer appearance of the publisher (the medium processing device) in a state where each unit is closed. FIG. 2 is a perspective view illustrating the outer appearance of the publisher in a state where each unit is opened. FIG. 3 is a perspective view illustrating the publisher viewed from an upper front side in a state where a case of the publisher is removed. FIG. 4 is a perspective view illustrating a label printer installed in the publisher.

As shown in FIG. 1, a disc publisher 1 is a medium processing device that writes data on circular disc-shaped media such as CDs or DVDs, reads data from the media, and prints on a label surface of the medium. The medium processing device includes a substantially rectangular parallelepiped case 2. Openable door 3 and 4 capable of being opened and closed are attached on a front surface of the case 2. An operation surface 5 provided with display lights, operation buttons, and the like is formed on an upper left of a front side of the case 2. In a lower portion of the case 2, leg portions 6 protruding downward are provided on right and left sides. A drawing mechanism 7 is provided between the right and left leg portions 6.

As shown in FIG. 2, the openable door 3, which is disposed on the right side on a front side of the medium processing device, opens and closes and provides an opening 8 on the front side of the disc publisher 1. The openable door 3 is a door is opened when unprocessed (blank) media M are set through the opening 8 or processed medium M are taken out through the opening 8, for example.

In addition, the openable door 4, which is disposed on the left side on the front side of the medium processing device, is opened when ink cartridges 12 of a label printer 11 shown in FIG. 3 are replaced. When the openable door 4 is opened, a cartridge mounting unit 14 having plural cartridge holders 13 arranged in a vertical direction is exposed.

Inside the case 2 of the disc publisher 1, a medium stacker 21 as a storage unit capable of stacking plural sheets (for example, 50 sheets) of unprocessed media M and a medium stacker 22 as a medium storage unit capable of stacking plural sheets (for example, 50 sheets) of unprocessed media M or processed media M are disposed vertically so that a central axis line of the stored media M are the same. The medium stacker 21 and the medium stacker 22 are detachably mounted at predetermined locations, respectively.

The upper medium stacker 21, which includes a pair of right and left arc frame plates 24 and 25, and receives the media M from an upper side and concentrically stacks the media M. A process of stacking media M in the medium stacker 21 can be simply carried out by opening the openable door 3 and taking out the medium stacker 21.

The lower medium stacker 22 has the same structure as that of the upper medium stacker 21. That is, the lower medium stacker 22 also includes a pair of right and left arc frame plates 27 and 28, and receives the media M from an upper side and concentrically stacks the media M.

A medium transporting mechanism 31 is disposed on a rear side of the medium stackers 21 and 22. The medium transporting mechanism 31 includes a vertical guide shaft 35 extending vertically between a main body frame 30 and a top plate 33 of a chassis 32. A transport arm 36 is supported by the vertical guide shaft 35 so as to ascend, descend, and rotate. The transport arm 36 is capable of ascending and descending along the vertical guide shaft 35 by the drive of a driving motor 37 and capable of rotating right and left on the vertical guide shaft 35.

On a side portion of a rear of the upper medium stacker 21, the lower medium stacker 22, and the medium transporting mechanism 31, two media drives 41 stacked vertically are disposed. In addition, a carriage 62 (see FIG. 4) of the label printer 11, which is described below, is movably disposed on a lower side of the media drives 41.

The media drives 41 are each provided with a medium tray 41a that moves between a position where data are written on a medium M and a position where the medium M is granted when the medium M are granted and received.

The label printer 11 includes a medium tray 45 capable of moving between a printing location where label printing on a label surface of the medium M is performed and the location where the medium M is granted when the medium M are granted and received.

FIG. 3 shows that the medium trays 41a of the upper and lower media drives 41 are drawn forward to be positioned at the location where the medium is granted and received and the medium tray 45 of the lower label printer 11 is positioned at the location where the medium is granted and received. In addition, the label printer 11 is an ink-jet printer and uses the ink cartridges 12 of respective colors (six colors of black, cyan, magenta, yellow, light cyan, and light magenta in this embodiment) as an ink supply mechanism 60. The ink cartridges 12 are mounted from a front side on respective cartridge holders 13 of the cartridge mounting unit 14.

Here, spaces where the transport arm 36 of the medium transporting mechanism 31 ascends and descends are formed between the pair of right and left frame plates 24 and 25 of the medium stacker 21 and between the pair of right and left frame plates 27 and 28 of the medium stacker 22. In addition, a space where the transport arm 36 of the medium transporting mechanism 31 rotates horizontally and is positioned directly above the medium stacker 22 is formed between the upper medium stacker 21 and the lower medium stacker 22. In addition, when both the medium trays 41a enter the media drives 41, the transport arm 36 of the medium transporting mechanism 31 descends to gain access to the medium tray 45 positioned at the location where the medium is received.

The transport arm 36 of the medium transporting mechanism 31 is capable of descending lower than the height location of the medium tray 45 in a state where both the medium trays 41a are positioned at the location where data are written and the medium tray 45 is positioned at an inward printing position. In addition, below the position of the medium tray 45 where the medium is granted and received, a guide hole 65 (see FIG. 2) in which a medium stacker (separate stacker) described below is formed as a guide for passing the medium M, which the transport arm 36 descends to the position releases.

The drawing mechanism 7 includes a drawing tray 70 capable of drawing and opening the medium from the main body frame 30 or receiving and closing the medium in a lower portion of the main body frame 30. In the drawing tray 70, a stacker unit 71 is formed downward in a concave shape. When the drawing tray 70 is positioned at a receiving location (close location), the stacker unit 71 is positioned below the guide hole 65 and the center of the stacker unit 71 is positioned so that central axis lines of both the medium tray 41a and the medium tray 45 at the location where the medium is granted and received are the same. The stacker unit 71 receives the medium M inserted through the guide hole 65 and holds a small number (for example, 5 sheets to 10 sheets) of the medium M. The stacker unit 71 receives the medium M from the upper side to concentrically stack the medium M.

In the stacker unit 71 of the drawing tray 70 in a received state and the guide hole 65, a medium stacker (separate stacker) 72 capable of receiving more medium M than the stacker unit 71 is detachably mounted (see FIG. 3). The medium stacker 72, which also includes a pair of arc frame plates 73 and 74, receives the medium M from the upper side and holds plural sheets (for example, 50 sheets) of medium so as to concentrically stack the medium. A space where the transport arm 36 of the medium transporting mechanism 31 ascends and descends is formed between one pair of the arc frame sheets 73 and 74. In addition, a grip 75 allowing a user to attach and detach the medium stacker 71 is provided above the frame plate 74.

When the medium stacker 72 is attached, the unprocessed media M are taken out from the lower medium stacker 22 to allow the media drive 41 and the label printer 11 to perform data recording and printing, and the media M are received in the medium stacker 72.

For example, the maximum number (50 sheets+50 sheets) of the unprocessed media M are loaded in the upper medium stacker 21 and the lower medium stacker 22, and all the sheets (50 sheets) of the media M loaded in the lower medium stacker 22 are processed in succession and received in the medium stacker 72. Next, all the sheets (50 sheets) of the media M loaded in the upper medium stacker 21 are processed in succession and received in the vacant lower medium stacker 22. In this way, the maximum number (50 sheets+50 sheets) of the media M loaded in the upper medium stacker 21 and the lower medium stacker 22 are processed at one time (batch processing mode).

When the medium stacker 72 is separated, the unprocessed media M are taken out from the upper medium stacker 21 or the lower medium stacker 22 to allow the media drive 41 and the label printer 11 to perform data recording and printing, and the media M are received in the stacker unit 71 of the drawing tray 70 in the received state.

Thereafter, by drawing the drawing tray 70, the processed media M are taken out from the stacker unit 71. That is, even while the media M are processed, one sheet or plural sheets of the processed medium M can be sequentially taken out from the stacker unit 71 with the openable door 3 closed (outside discharge mode).

Here, by combination operations of ascending, descending, right rotation, and left rotation by the transport arm 36 of the medium transporting mechanism 31, the medium M are appropriately transported among the medium stacker 21, the medium stacker 22, the stacker unit 71 (or the medium stacker 72) of the drawing tray 70, the medium tray 41a of each media drive 41, and the medium tray 45 of the label printer 11.

As shown in FIG. 4, the label printer 11 is provided with the carriage 62 that includes an ink-jet head (print head) 61 with nozzles (not shown) for ink ejection. The carriage 62 reciprocates in a horizontally along a guide shaft (not shown) by a driving force of a carriage motor 68.

The label printer 11 is provided with the ink supply mechanism 60 that includes the cartridge mounting unit 14 mounted in which the ink cartridges 12 are. The ink supply mechanism 60, which have a longitudinal shape, is erected on the main body frame 30 of the publisher 1 to be arranged in the vertical direction. One end of a flexible ink supply tube 63 is connected to the ink supply mechanism 60 and the other end of the ink supply tube 63 is connected to the carriage 62.

Ink of each ink cartridge 12 mounted on the ink supply mechanism 60 is supplied to the carriage 62 through the ink supply tube 63. In addition, the ink is supplied to the ink-jet head 61 through a damper unit and a back-pressure adjusting unit (not shown) provided in the carriage 62 to be ejected from ink nozzles (not shown).

The ink supply mechanism 60 includes a pressurizing mechanism 64 so that major elements are disposed in the upper portion. Accordingly, the pressurizing mechanism 64 pressurizes the inside of each ink cartridge 12 by sending compressed air to supply the ink stored in an ink pack of each ink cartridge 12.

A head maintenance mechanism 81 is provided below a home position (location shown in FIG. 4) of the carriage 62.

The head maintenance mechanism 81 includes a head cap 82 which covers the ink nozzles of the ink-jet head 61 exposed to the lower surface of the carriage 62 disposed at the home position; and a used-ink sucking pump 83 which sucks the ink discharged to the head cap 82 by a head cleaning operation or an ink filling operation on the ink-jet head 61.

The ink sucked by the used-ink sucking pump 83 of the head maintenance mechanism 81 is sent to a used-ink absorbing tank 85 through a tube 84.

In the used-ink sucking tank 85, an adsorption material is disposed within a case 86 and an upper surface of the used-ink absorbing tank 85 is covered with a cover 88 having plural airing holes 87.

In the lower portion of the head maintenance mechanism 81, a used-ink receiver 89 that is a part of the used-ink absorbing tank 85 is provided so as to receive ink dropped from the head maintenance mechanism 81 and to absorb the dropped ink by the adsorption material.

As shown in FIGS. 2 and 3, the media drives 41 are stacked in a limited space within the disc publisher 1, so that a gap between the media drives 41 that are easily heated may particularly have a high temperature. In addition, in order to maintain a good writing quality in the media drives 41, an ambient temperature of the media drives 41 is required to satisfy an operation guarantee temperature. Accordingly, according to this embodiment, the disc publisher 1 is provided with a cooling mechanism that introduces air from the outside into the gap between the media drives 41 in order to effectively cool the media drives 41.

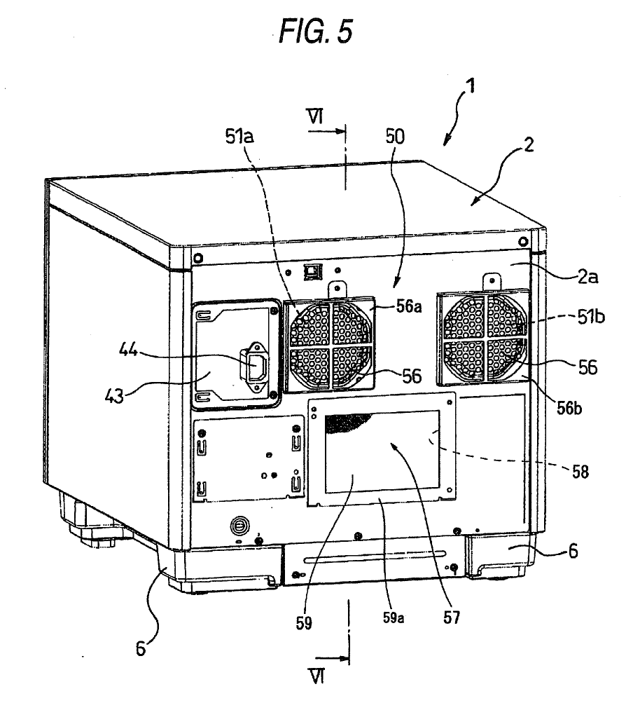

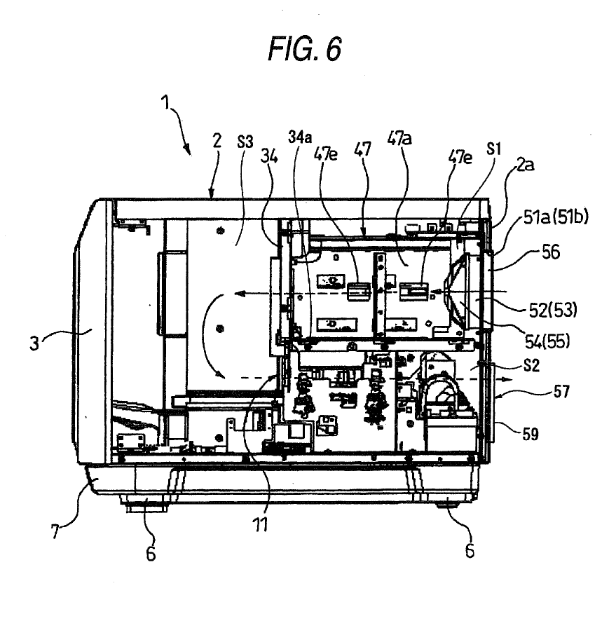

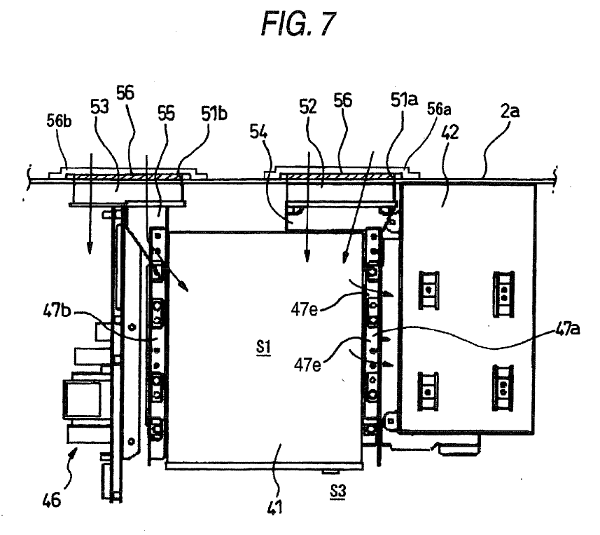

As shown in FIG. 5, a cooling mechanism 50 that cools the inside of the case 2 by introducing air from the outside is provided on a rear surface panel 2a detachably mounted on the rear surface of the case 2. In the upper portion of the rear surface panel 2a, notched holes (air introduction ports) 51a and 51b are formed right and left to allow outside air to flow into the inside of the case 2 from the rear side of the disc publisher 1. As shown in FIGS. 6 and 7, fans 52 and 53 and hoods 54 and 55 are attached to the inside surface of the rear surface panel 2a at the locations of the notched holes 51a and 51b. The fans 52 and 53 and the hoods 54 and 55 may be integrally formed, or frames having the fans 52 and 53 are attached to the rear surface panel 2a and the hoods 54 and 55 may be attached inside the frames, respectively.

Filters 56 and filter cases 56a and 56b are interchangeably attached to the outside surface of the rear surface panel 2a at the locations of the notched holes 51a and 51b, that is, an upstream side for introducing the outside air by the fans 52 and 53. Therefore, upon introducing the outside air into the inside of the case 2, dusts or the likes of the outside air are captured. With such a configuration, dusts or the like are prevented from entering the inside of the disc publisher 1. Accordingly, by preventing dusts from being deposited to the media M, it is possible to prevent deterioration of a data writing quality or a label-surface printing quality. Moreover, by preventing lenses used to write data by the media drives 41 from getting dirty from dust deposition, it is possible to maintain a good writing quality. In addition, by appropriately replacing the filters 56, it is possible to maintain an optimal cooling performance.

As shown in FIGS. 5 and 6, a discharge port 57 for discharging the air inside the case 2 to the rear side of the disc publisher 1 is provided below the rear-surface panel 2a. The discharge port 57 is provided below the rear-surface panel 2a so as to include a notched hole 58 for discharging the air inside the case 2 to the rear side of the disc publisher 1, a mist adsorption filer 59 interchageably attached to cover the notched hole 58 mainly by a fabric, and a filter case 59a of the mist adsorption filer 59, so that ink mist or the like is captured by the mist adsorption filer 59 upon discharging the air to the outside of the case.

On the left side of the cooling mechanism 50, the power unit 42 provided inside the case 2 in FIG. 7 is detachably mounted on the outside surface of the rear surface panel 2a, and a power connection member 44, which is shown in FIG. 5, connected to a external power source is provided on a cover 43 of the power unit 42. In addition, a small notched hole for discharging the inside air is formed on the cover 43.

Inside the case, 2, as shown in FIG. 6, a rear upper space (first part) S1 and a rear lower space (second part) S2 are divided by a partition plate 34a that extends in horizontal direction of a frame 34 having an L shape in across section inside the case 2. The rear upper space S1 and the rear lower space S2 are in communication with each other through a front space (third part) S3, as shown in FIG. 6, where the medium stackers 21 and 22 and the medium transporting mechanism 31 shown in FIG. 3 are disposed. In the front space S3 close to the rear upper space S1, the fans 52 and 53 are provided in the opposite rear portion of the case. In addition, in the front space S3 close to the rear lower space S2, the discharge port 57 is provided in the opposite rear portion of the case. According to this embodiment, there are provided the notched holes (air introduction ports) 51a and 51b for allowing air across the rear surface of the case 2 from the outside and the air discharge port 57 for allowing the air to flow to the inside the case 2. It is preferable that the notched holes and the discharge port are spaced from a wall surface on which the disc publisher 1 is installed. It is also preferable that the power connection member 44 is mounted on the side spaced from the wall surface since the power connection member 44 can be used as an attachment space of a power cord (which is illustrated) to be inserted to the power connection member 44 protruding from the disc publisher 1.

In the rear upper space S1 divided by the frame 34 having the L shape in across section, as shown in FIG. 7, the media drives 41 are provided in the center of the medium processing device, the power unit 42 is provided on the left side of the medium processing device, and a board unit 46 is provided on the right side of the medium processing device. In the rear lower space S2, as shown in FIG. 6, a label printer 11 is provided. That is, the carriage 62 having the ink-jet head 61 of the label printer 11 shown in FIG. 4 is disposed in the rear lower space S2 to reciprocate in the rear lower space S2.

The stacked media drives 41 are surrounded by a media drive frame 47 shown in FIG. 6 so as to be attached to the upper surface of the partition plate 34a of the frame 34 with the media drive frame 47 interposed therebetween. On a side plate 47a of the media drive frame 47, notched holes 47e are formed in correspondence to the height of the gap between the media drives 41.

The fans 52 and 53 are disposed in the rear upper space S1, as described above, so that the central height location of the fans 52 and 53 accords with the height location of the gap between the stacked media drives 41. With such a configuration, the air introduced by the fans 52 and 53 is actively directed to flow toward the gap between the media drives 41.

Some of the air flowing toward the gap between the media drives 41 also cools the power unit 42 by flowing some of the air toward the power unit 42 through the notched holes 47e, as indicated by an arrow in FIG. 7, and discharging some of the air from a notched hole of the cover 43 to the outside. The air passing through the media drives 41 flows through the front space S3.

In the rear lower space S2 where the discharge port 57 is disposed, the label printer 11 is provided, as shown in FIG. 6.

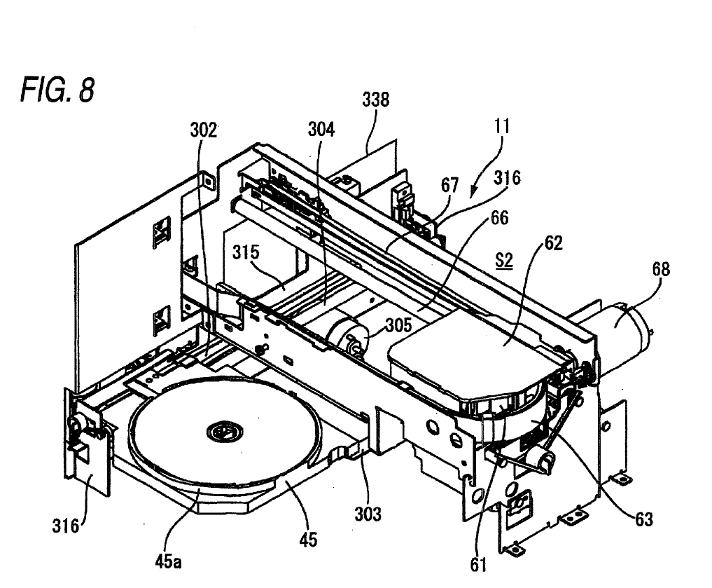

As shown in FIG. 8, a nozzle surface of the ink-jet head 61 mounted on the carriage 62 is oriented downward. The medium tray 45 reciprocates horizontally in the front and rear directions below the ink-jet head 61. The right end of the medium tray 45 is supported by a guide shaft 302 extending horizontally in the front and rear directions, and the left end thereof is slidably supported by a guide rail 303 extending horizontally in the front and rear directions.

A driving mechanism of the medium tray 45 includes a timing belt 304 suspended horizontally in the front and rear directions and a tray motor 305 driving the timing belt 304. The medium tray 45 includes in the upper surface of the rectangular plate a circular low convex portion 45a that comes in contact with the circumferential cross-face of the medium to regulate the movement of the medium.

Next, a belt driving mechanism moving the medium tray 45 will be described.

In the medium tray 45 moved by the belt driving mechanism 310, a guide shaft 311 extending horizontally in the front and rear directions of the medium processing device is perforated through a slide bearing 311 formed on one side, and a slide piece 313 formed on the other side is slidably placed in a guide rail 303 extending horizontally in the front and rear directions of the medium processing device. With such a configuration, the medium tray 45 is supported to be slidable in the front and rear directions of the medium processing device by the guide shaft 302 and the guide rail 303.

The guide shaft 302 is disposed at a distance along a frame 315 in the front and rear directions of the medium processing device, so that both the ends of the guide shaft 302 are fixed to fixing plates 316, which are formed on the two ends of the frame 315.

On the frame 315, a driving pulley 321 is rotatably provided in the vicinity of the end on the rear side of the medium processing device and a driven pulley 322 is rotatably provided in the vicinity of the end on the front side of the medium processing device. The timing belt 304 is suspended on the driving pulley 321 and the driven pulley 322. One side of the medium tray 45 is firmly fixed to the timing belt 304 by a belt clamp 324. With such a configuration, the medium tray 45 is slid by the drive of the timing belt 304 in a drive direction.

An encoder plate 332 and a delivery pulley 333 are fixed to a rotational shaft 331 of the driving pulley 321. The tray motor 305 is provided below the frame 315 and a rotational pulley 336 is provided in a driving shaft 335 of the tray motor 305. A delivery belt 327 is suspended on the delivery pulley 333 and the rotational pulley 336.

On the encoder plate 332, plural location detecting slits are formed at the same interval along the circumference of the encoder plate 332, so that a location detector (not shown) detects the location detecting slits of the encoder plate 332. In addition, the location of the medium tray 45 is detected on the basis of a detection signal from the location detector.

In the belt driving mechanism 310, the tray motor 305 is driven to rotate the driving shaft 335, when driving current having a current value calculated on the basis of PID control as control means is output. Then, a rotational force of the driving shaft 335 is delivered to the rotational shaft 331 of the driving pulley 321 by the delivery belt 327 suspended on the rotational pulley 336 and the delivery pulley 333, so that the driving pulley 321 rotates.

In this way, when the driving pulley 321 rotates, the timing belt 304 suspended on the driving pulley 321 and the driven pulley 322 travels, so that the medium tray 45 firmly fixed to the timing belt 304 is moved in the front and rear directions of the medium processing device.

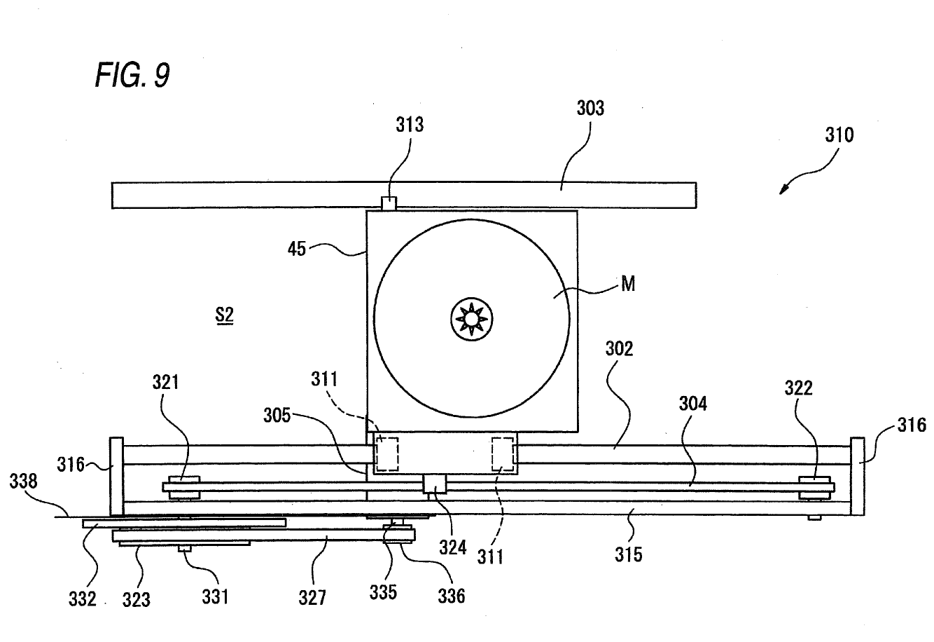

Here, the ink-jet head 61 mounted on the carriage 62 shown in FIG. 8 is disposed in the rear lower space S2. As shown in FIG. 9, the isolation plate 338 for isolating the encoder plate 332 from the rear lower space S2 is provided between the encoder plate 332 and the frame 315.

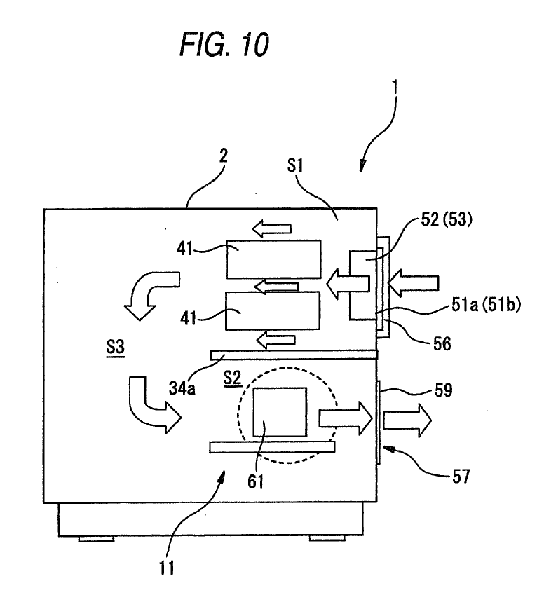

As indicated by the arrows shown in FIGS. 6 and 10, the fans 52 and 53 provided in the notched holes 51a and 51b opened to the rear upper space S1 suck air from the outside and allow the air in the case 2. Then, the air is first introduced to the rear upper space S1 divided by the partition plate 34a.

The introduced air passes through the media drives 41 disposed in the rear upper space S1 to cool the media drives 41 by removing heat from the media drives 41, and the air is delivered to the front space S3 in which the medium stackers 21 and 22 and the medium transporting mechanism 31 show in FIG. 3 are disposed.

Some of the air passes through the power unit 42 from the notched holes 47e shown in FIG. 6, as indicated by the arrows in FIG. 7, to cool the power unit 42 by removing heat from the power unit 42 and discharge the air. Thereafter, as shown in FIG. 10, the air in the front space S3 passes through the ink-jet head 61 of the label printer 11 disposed in the rear lower space S2, and then is discharged from the discharge port 57. At this time, the air passing through the ink-jet head 61 contains an ink mist, but the mist adsorption filter 59 provided in the discharge port 57 captures the ink mist.

In the disc publisher (medium processing device) 1 according to this embodiment, the ink mist occurring in the label printer 11 is not diffused into the front space S3 in order to actively cool the media drives 41, which are easily heated to turn into a high temperature. The air introduced from the outside by the fans 52 and 53, where the media drives 41 are disposed, is discharged from the discharge port 57 provided in the partition, where the label printer 11 is disposed, through the front space S3 where the medium stackers 21 and 22 and the medium transporting mechanism 31 are disposed. Accordingly, a problem does not occur in that the detachable medium stackers 21, 22, and 72 disposed in the front space S3 and the medium received in the medium stackers before printing, and the medium transporting mechanism 31 are not stained. In particular, the advantage of not staining the medium stacker 72 positioned at a location where the problem with the staining easily occurs is that the quality of the disc publisher 1 is not degraded.

Moreover, the mist adsorption filter 59 provided in the discharge port 57 adsorbs the ink mist occurring in the label printer 11. With such a configuration, it is possible to effectively restrain the ink mist from diffusing inside and outside, while cooling the media drives 41 to maintain the operation guarantee temperature.

Since the partition plate 34a is provided between the label printer 11 and the media drives 41 and the power unit 42, the air introduced from the outside by the fans 52 and 53 flows into the rear upper space S1 where the media drives 41 and the power unit 42, the front space S3 where the medium transporting mechanism 31, and the rear lower space S2 where the label printer 11 is disposed, so that an air stream to the discharge port 57 is generated.

With such a configuration, it is possible to effectively restrain the ink mist from diffusing inside and outside, while cooling the media drives 41 to maintain the operation guarantee temperature. Moreover, it is possible to restrain the ink mist from diffusing to the power unit 42 and the medium transporting mechanism 31.

Since the partition plate 338 is provided for isolating the encoder plate 332 from the rear lower space S2 where the ink-jet head 61 is disposed, it is possible to restrain the ink mist from being deposited to the encoder plate 332 and maintain high detection precision of the medium tray 45.

An additional fan may be provided for discharging air by force. Accordingly, since the air in the front space S3 can be discharged from the discharge port 57, a possibility that the ink mist occurring in the label printer 11 diffuses to the front space S3 is further decreased, and the elements disposed in the front space S3 or the medium transporting mechanism 31 are not stained. Moreover, it is possible to obtain an advantage of capturing air containing the ink mist by the mist adsorption filter 59 using a stronger air stream. To flow the air within the case 2, the fan may be disposed at any positions on an air flow path from the air introduction ports 51a, 51b to the discharge port 57. Only one fan may be provided in the air flow path. Further, means for flowing the air within the case 2 is not limited to the fan.

The medium is not limited to the disc-shaped medium such as the medium M described in the embodiment, but may be applied to medium having a polygonal shape such as a rectangular shape or an elliptic shape, or any other shape. Moreover, the recording method is not limited to an optical recoding method or a magneto-optical recoding method.

In the above embodiment, the media drive is a component of the medium processing device whose performance is sensitive to particle deposition caused by dust or other particle sources inside the medium processing device. Also, the ink-jet printer is a component of the medium processing device whose normal operation provides a particle source that affects the performance of other components of medium processing device. The present invention is not limited to a media drive as the component sensitive to deposition of particles or to a ink-jet printer as the component that deposits particles.

Moreover, the ink-jet printer performing printing on the label surface of the medium is used as an example of an ink-jet device, but the invention is not limited thereto. The invention may be applied to ejection devices in which a mist occurs at ejection time.

What is claimed is:

1. A medium processing device, comprising:
a case defining a space;
a storage unit that is configured to store a medium;
a media drive that is operable to perform at least one of writing data on the medium and reading data from the medium;
a liquid ejecting unit that is operable to eject liquid onto a surface of the medium;
an air introducing port that is configured to introduce air into the space from outside of the space; and
an air discharging port that is configured to discharge the air to the outside from the space,
wherein the space includes a first part in which the media drive is disposed, a second part in which the liquid ejecting unit is disposed and a third part in which the storage unit is disposed;
wherein the air introducing port is provided in the first part and the air discharging port is provided in the second part; and
wherein the first part, the second part and the third part are disposed so that the air is introduced into the first part, flows through the third part and is discharged from the second part.

2. The medium processing device as set forth in claim 1, further comprising at least one fan that is configured to allow the air to flow from the outside into the first part through the air introducing port,
wherein the air introducing port is provided with the fan.

3. The medium processing device as set forth in claim 1, further comprising at least one filter that is configured to absorb the liquid diffused in the form of a mist,
wherein the air discharging port is provided with the filter.

4. The medium processing device as set forth in claim 1, further comprising at least one fan that is configured to allow the air to flow from the second part to the outside through the air discharging port,
wherein the air discharging port is provided with the fan.

5. The medium processing device as set forth in claim 1, wherein the liquid ejecting unit includes an ink-jet printer that is operable to print on the surface of the medium.

6. The medium processing device as set forth in claim 1, wherein the storage unit includes at least one stacker that is configured to accommodate the medium and is detachably mounted in the third part.

7. The medium processing device as set forth in claim 1, further comprising a power unit of the medium processing device,
wherein the power unit is disposed in the first part.

8. The medium processing device as set forth in claim 1, further comprising at least one medium transporting mechanism that is operable to transport the medium between the storage unit and a tray of the media drive or a tray of the liquid ejecting unit,
wherein the transporting mechanism is disposed in the third part.

9. The medium processing device as set forth in claim 1, further comprising an encoder plate that is operable to detect a location of a tray of the liquid ejecting unit,
wherein the liquid ejection unit includes a printing head; and
wherein encoder plate is spaced apart from the printing head.

10. A medium processing device, comprising:
a case defining a space;
a first component sensitive to deposition of particles;
a second component that deposits particles on a medium;
an air introducing port that is configured to introduce air into the space from outside of the space; and
an air discharging port that is configured to discharge the air to the outside from the space,
wherein the space includes a first part in which the first component is disposed, a second part in which the second component is disposed and a third part in which the medium is stored;
wherein the air introducing port is provided in the first part and the air discharging port is provided in the second part; and
wherein the first part, the second part and the third part are disposed so that the air is introduced into the first part, flows through the third part and is discharged from the second part.
